(19) United States
(12) Patent Application Publication
(10) Pub. No.: US 2002/0172751 A1
(43) Pub. Date: Nov. 21, 2002

(54) Oil having increased polyphenol content

(75) Inventors: Henk Husken, Vlaardingen (NL); Stephanie Kooij, Vlaardingen (NL); Karel Petrus Van Putte, Vlaardingen (NL)

Correspondence Address: UNILEVER, PATENT DEPARTMENT, 45 RIVER ROAD, EDGEWATER, NJ, 07020, US

(73) Assignee: Lipton, Division of Conopco, Inc.

(21) Appl. No.: 10/025,294

(22) Filed: Dec. 19, 2001

(30) Foreign Application Priority Data
Dec. 22, 2000 (EP) 00204714.0

(51) Int. Cl. A23L 1/24

(52) U.S. Cl. 426/605

(57) ABSTRACT

The present invention provides a method for increasing the polyphenol content in an oil, comprising the steps of contacting the oil with olive fruit material in the presence of an acid and separating the oil from the olive fruit material. The acid is preferably hydrochloric acid, citric acid, phosphoric acid, acetic acid, lactic acid or ascorbic acid. The olive fruit material can be selected from the group consisting of whole olive fruits, olive fruit particles and olive residue.

The present invention relates to a method for increasing the polyphenol content of a triglyceride oil, in particular a vegetable oil and to the oil obtained with such a method. The invention relates also to food products containing a certain amount of such oil, such as spreads, mayonnaises, salad dressings and sauces.

### BACKGROUND OF THE INVENTION

Fats and oils form a substantial part of the average human food consumption. Since fat consumption is associated with an increased risk of cardiovascular disorders, the nutritional value of different types of fat as well as methods for reducing the amount of fat in food products has been the object of extensive investigation.

Recently, also the nature and the effects on health of fat attributes, the so-called minor nutrients which are present in small amounts in non-refined natural fats is subject of such investigations. It has been found that the minor nutrients which are denoted as anti-oxidants, including fat polyphenols, positively interfere with the body's cardiovascular system. Polyphenols are compounds which share a phenolic hydroxyl group. Usually polyphenols are present not as a single compound but as a mixture of different polyphone's. One of the sources of polyphenols are olives. Olive fruit originating polyphenols are for example oleuropein, aglycons, tyrosol or hydroxytyrosol.

Traditionally, most natural fats are refined before they are used as an ingredient for the preparation of food. However, traditional fat refining aims at the removal of all substances other than triglycerides, including minor nutrients. such as natural anti-oxidants, particularly the typical olive oil polyphenols. Therefore, there exists a need for increasing the level of anti-oxidants in oils or fats.

Several methods are proposed in the prior art to attain said goal. In WO 00/38541 it is for instance described to incorporate solid matter derived from non-debittered olive fruit in a food product such as a vegetable oil. In U.S. Pat. No. 6,162,480 olive fruits are soaked in vegetable oil, preferably olive oil to diffuse polyphenols into the surrounding oil.

It is known to mix an olive fruit material with an acid when preparing certain food products such as for instance “tapenade” like products. In FR A 2 337 509 and FR A 2 499 368 products based on olives are described which are prepared by mixing olive pulp with flavouring agents such as pepper, chillies, etc., oil and citric acid or lemon juice. In these products it is intended to maintain the mixture of olive pulp and oil.

According to the invention a novel method has been found to increase the level of antioxidants such as polyphenols in (refined) oils and fat based products such as spreads, mayonnaise, salad dressings and sauces. A further object is to increase the level of such antioxidants in an oil without deterioration of colour and taste of the oil.

### SUMMARY OF THE INVENTION

Those and other objects are attained by the method of the present invention, which comprises the steps of mixing the oil with olive fruit material and an aqueous acid solution obtaining a mixture, maintaining the mixture for at least 1 minute and separating the oil from the olive fruit material and the aqueous acid solution.

By means of this method the beneficial antioxidant components present in olive fruit material are released from the olive fruit material and extracted into the oil. After separation of the olive fruit material and the aqueous acid solution a clear oil is obtained having good taste and color properties and an increased polyphenol level.

### DETAILS OF THE INVENTION

The acid to be used for this method is in particular hydrochloric acid or a food grade acid such as citric acid, phosphoric acid, acetic acid, lactic acid, ascorbic acid or any other food grade acid. The acid is added to the mixture of oil and olive fruit material, preferably as a concentrated aqueous solution, for instance containing more than 30% (w/w) acid. The aqueous acid solution has a pH of 4 or less, preferably 2 or less. Most preferably the pH is between 0 and 1. In general to obtain such pH, the amount of acid added is 0.1 to 30 wt. %, preferably 0.5 to 5 wt. %, based on pure acid and the weight of the mixture of oil and olive fruit material.

The olive fruit material can be whole olive fruits, olive fruit particles or olive residue. With olive residue is meant the residue that remains after production of olive oil by malaxation of olive fruits. Such a residue usually has a water content of about 50 to 70 wt. % and can have a polyphenol content of e.g. 2000 to 30,000 ppm (wt/wt). The polyphenol content varies for instance depending on the ripeness or the origin of the olives. The amount of olive fruit material in the oil is 0.1 to 50 wt. %, preferably 1 to 30 wt. %, based on the weight of the oil.

The temperature at which the oil is contacted with the olive fruit material is at least 10° C. However, the method according to the invention is carried out preferably at elevated temperatures. This increases the amount of polyphenols transferred to the oil. Preferably, the oil is contacted with the olive fruit material at a temperature of at least 50° C., more preferably at least 70° C., most preferably 90 to 100° C.

The optimal time for contacting oil and olive fruit material can be determined by a skilled person. In general this period will be at least 30 minutes, preferably at least 90 minutes. Preferably the mixture of oil, olive fruit material and aqueous acid solution is stirred during the contact time. Increasing the stirring rate will increase contact area and thus mass transfer of the polyphenols to the oil. At the end of the contact time the oil is separated from the olive fruit material and aqueous acid solution such as by filtration or decanting, preferably by centrifugation.

Preferably, the method according to the present invention is used to fortify vegetable oils. Examples of vegetable oils which can be fortified according to the invention are olive oil, rapeseed oil, sunflowerseed oil, soybean oil and corn oil. Preferably olive oil is fortified. The invention is not limited to fortification of oils which are devoid of any polyphenol, either by nature or because of a refining process, but also relates to oils which contain polyphenols of their own such as (extra) virgin olive oils. Examples of other olive oils which can be fortified according to the present invention are an extra virgin olive oil, a fine virgin olive oil, a semi-fine or regular virgin olive oil, a refined virgin olive oil, such as a Lampante oil, or an olive residue oil but also an olive oil blend, which contains part virgin olive oil and part refined olive oil.

The present invention thus also relates to the oil obtained with the above described method. The oil will have a polyphenol content of more than 150 ppm (wt/wt). The total content of polyphenols in oil can be established by standard methods, e.g. by the calorimetric Gutfinger method as described in J.Am.Oil.Chem.Soc. 1981, 11, pp. 966-968, which method is based on the reaction of a methanolic extract of olive oil and the Folin-Ciocalteau reagent. Polyphenol content can also be determined by HPLC. Another characteristic of the oil of this invention is that it is a clear oil, even though it contains a high amount of polyphenols. In particular the invention provides a clear, pure olive oil having a polyphenol content higher than 150 ppm (wt) (expressed as mg/kg caffeic acid equivalents).

The oil obtained with the invention can also be characterised by its HPLC chromatogram. It has appeared, as will be shown in the examples, that the oil of the invention is novel because its HPLC profile is different from the HPLC profile of current extra virgin olive oils or oils contacted with olive fruit material without the presence of acid. The profile of the oil of the invention is characterised by at least one distinguished peak situated between the peaks originating from aglycons which contain hydroxytyrosol or tyrosol moieties and the group of peaks originating from hydroxytyrosol and tyrosol themselves of which at least one peak corresponds to a concentration of at least 1 ppm. In particular three peaks are present in this area. The concentration of the component corresponding with the peak obtained can be estimated using known peak area/concentration relationships for tyrosol and hydroxy tyrosol.

When the following HPLC conditions are applied:

a Chrompack Intersil5 ODS column (reversed phase column), a gradient flow rate of 1 ml/min and an elution system consisting of solvent A (2% acetic acid in water) and solvent B (methanol), gradient: 0-20 min., A/B 85/15%; 20-50 min., 15-75 B in A; 50-55 min., A/B 25/75, 55-56 min 75-100 B in A; 56-65 min., 100% B

the chromatogram of the oil shows at least one peak, in particular three peaks, in the area of a retention time of 15 to 30 minutes.

The present invention also relates to food products containing the fortified oil. These food products can be mixtures of the fortified oil and another oil, but also products such as a spread, salad dressing, mayonnaise or sauce. Spreads are food compositions which usually contain a substantial amount of fat, often 40 wt. % or more. Usually the fat consists of a liquid oil and a structuring fat which gives the fat blend a proper consistency. Sauces are meant to include any type of sauce, for instance sauces that are ready to use, in particularly after having been heated, such as for instance tomato sauces. Processes for the manufacture of these products are well known in the art and need no illustration.

It goes without saying that the invention is not restricted to oils which only have a vegetable origin. Animal oils, including fish oil, can also be used. It might be advantageous to use a fat blend which partly consists of animal fat and/or marine oils or fats derived from such fats/oils by fractionation or interesterification. Fat and oil are terms which are used interchangeably in this specification. The term oil is generally used when the fat is liquid at ambient temperature.

### BRIEF DESCRIPTION OF THE FIGURES

The invention will now be further described by means of the non-limiting examples and the attached figures, wherein

FIG. 1 shows the increase of polyphenols in refined olive oil using concentrated hydrochloric acid;

FIG. 2 shows the increase of polyphenols in refined olive oil using citric acid;

FIG. 3 shows a HPLC analysis of a sample according to example 3 after 30 minutes; and

FIG. 4 shows a HPLC analysis of a sample according to example 3 after 126 minutes and the addition of HCl.

### EXAMPLES

### Example 1

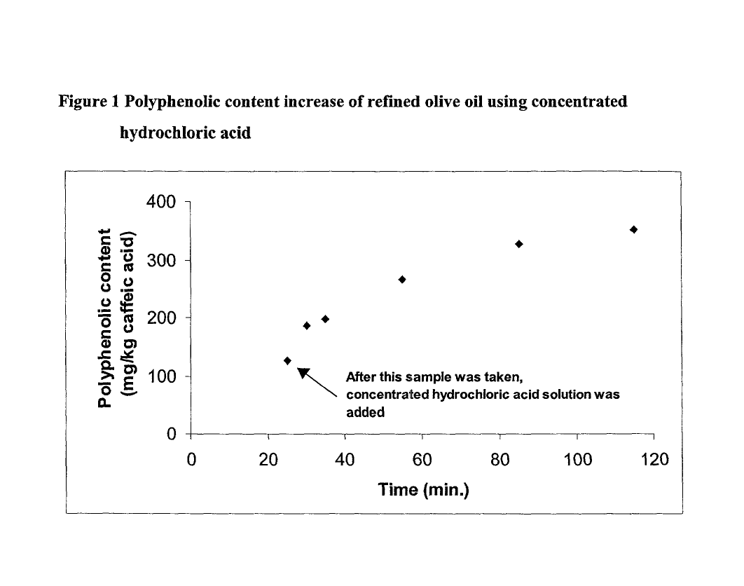

To 101.6 grams of olive residue, 205.5 grams of refined olive oil was added. The mixture was stirred mechanically and the temperature was subsequently raised to 95° C. The mixture was allowed to equilibrate. After 25 minutes a sample was taken and analysed for polyphenols using the Gutfinger method. Then 5 ml of a concentrated hydrochloric acid solution (37%) was added to the mixture. After several time intervals samples were taken and subsequently analysed for polyphenols using the Gutfinger method. In order to remove solids and water from the samples, the samples were centrifuged at 3500 rpm for 30 minutes. Results of the Gutfinger analysis are reported in FIG. 1. Polyphenol content increases quickly after addition of concentrated hydrochloric acid.

### Example 2

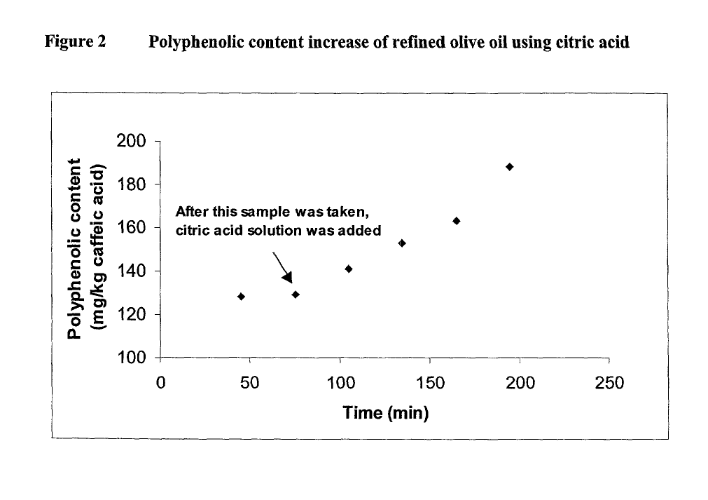

To 101.4 grams of olive residue, 206.1 grams of refined olive oil was added. The mixture was stirred mechanically and the temperature was subsequently raised to 95° C. The mixture was allowed to equilibrate. After 50 minutes and 80 minutes a sample was taken and analysed for polyphenols using the Gutfinger method. Then 10 ml of a citric acid solution (60% w/w) was added to the mixture. After several time intervals samples were taken and subsequently analysed for polyphenols using the Gutfinger method. In order to remove solids and water from the samples, the samples were centrifuged at 3500 rpm for 30 minutes. Results of the Gutfinger analysis are reported in FIG. 2. Polyphenol content increases quickly after addition of citric acid.

### Example 3

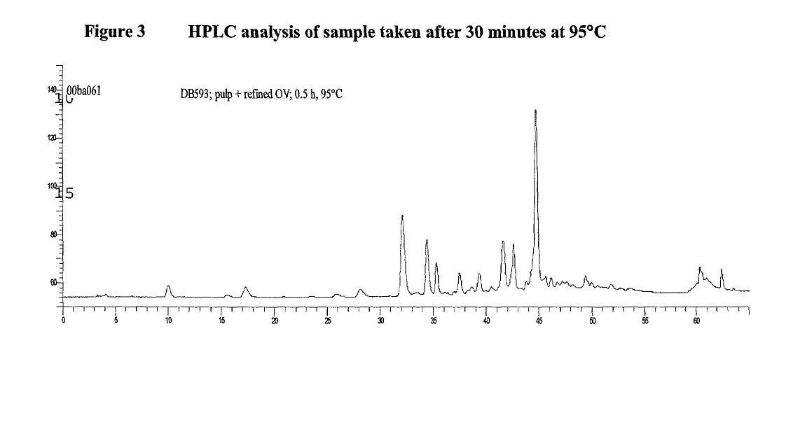

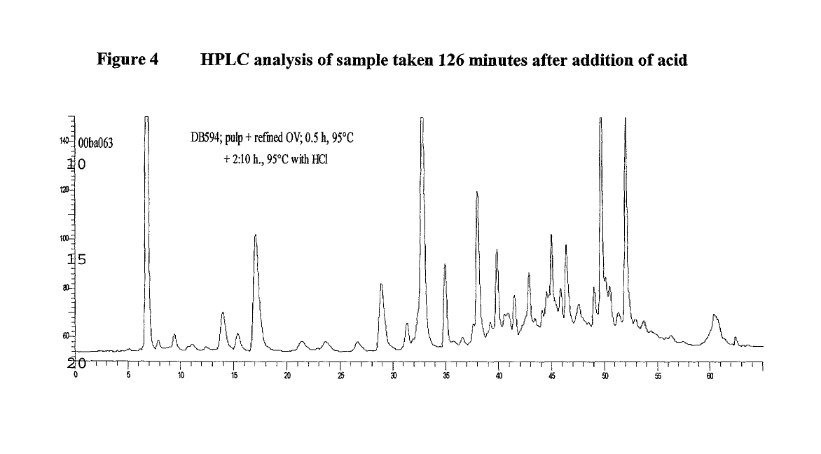

To 154.8 grams of olive residue, 303.5 grams of refined olive oil was added. The mixture was stirred mechanically and the temperature was subsequently raised to 95° C. The mixture was allowed to equilibrate. After 30 minutes a sample was taken and analysed for polyphenols using the Gutfinger method and analysed for the polyphenols composition using the HPLC method. Then 7.5 ml of a concentrated hydrochloric acid solution (37%) was added to the mixture. After 126 minutes a samples was taken and subsequently analysed for polyphenols using the Gutfinger method and analysed for the polyphenols composition using the HPLC method. In order to remove solids and water from the samples, the samples were centrifuged at 3500 rpm for 30 minutes. Results of the Gutfinger analysis are reported in table 1. The results of the HPLC analysis are reported in table 2. Table 2 also shows concentrations of compounds of which the retention time and the relationship concentration/peak area are known. The chromatograms are shown in FIGS. 3 and 4.

For HPLC analysis the following method was used. The analytical separations were performed on a Waters 600 S liquid chromatograph equipped with a waters 616 pump and a waters 490 UV multiwavelength detector. Injection of the samples was carried out by a 10 ul Rheodyne sample loop. A chrompack 25 cm*4.6 mm ¼ inch Intersil5 ODS column was applied using a gradient flow rate of 1 ml/min. The elution system consisted of solvent A (2% acetic acid in water) and solvent B (methanol). Gradient: 0-20 min., A/B 85/15%; 20-50 min., 15-75 B in A; 50-55 min., A/B 25/75, 55-56 min 75-100 B in A; 56-65 min., 100% B. UV was measured at 280 nm (for quantification) and 239 nm.

TABLE 1
Polyphenolic content

| | Polyphenolic content |
|---|---|
| Sample | (mg/kg caffeic acid) |
| 30 minutes at 95° C. | 146 |
| 126 minutes after | 397 |
| adding acid | |

TABLE 2
HPLC results

| | | | | 126 min. | |
|---|---|---|---|---|---|
| | | | | after | |
| Reten- | 30 | 30 min. at | 126 min. | adding | |
| tion | min. | 95° C. | after | acid | |
| Time | at | (concentra- | adding | (concentra- | |
| (min- | 95° C. | tion) | acid | tion) | Com- |
| utes) | (area) | (mg/kg) | (area) | (mg/kg) | ponent |
| 4.04 | 21923 | | | | |
| 6.65 | 8742 | | 4178232 | | |
| 7.76 | | | 135771 | | |
| 9.27 | 128361 | 1.7 | 145286 | 2.0 | Hydroxy |
| | | | | | tyrosol |
| 10.92 | | | 63763 | | |
| 14.88 | 36113 | | 607732 | | |
| 15.45 | | | 235714 | | |
| 16.37 | 149375 | 4.0 | 1832740 | 48.9 | Tyrosol |
| 21.47 | | | 221384 | 3-6* | |
| 25.32 | 58590 | | 241784 | 3-7* | |
| 27.67 | 128080 | | 168907 | 2-5* | |
| 30.44 | | | 1023006 | | |
| 31.70 | 903041 | | 298597 | | |
| 33.46 | 50968 | | 3231294 | | |
| 34.05 | 502165 | | 716243 | | |
| 35.37 | 247782 | | 50434 | | |
| 36.71 | 28473 | | 82153 | | |
| 37.25 | 190364 | | 103863 | | |
| 38.40 | 54189 | | 1351964 | | |
| 39.05 | 165608 | | 98697 | | |
| 39.92 | 6239 | | 600276 | | |
| 40.10 | 37375 | | 28175 | | |
| 40.96 | 520092 | 18.0 | 244570 | 5.0 | Hydroxy |
| | | | | | tyrosol |
| | | | | | related |
| | | | | | aglycon |
| 41.78 | 403506 | | 28754 | | |
| 42.50 | | | 84376 | | |
| 42.83 | | | 380553 | | |
| 43.50 | | | 19008 | | |
| 43.94 | 59003 | | 266661 | | |
| 44.42 | 1745343 | 49.0 | 943163 | 23.8 | Tyrosol |
| | | | | | related |
| | | | | | aglycon |
| 45.60 | 124423 | | | | |
| 45.30 | 81431 | | | | |
| 45.80 | 55349 | 1.5 | 744871 | 9.7 | Hydroxy |
| | | | | | tyrosol |
| | | | | | related |
| | | | | | aglycon |
| 46.42 | 81431 | | | | |
| 46.93 | 56294 | 19.5 | 189785 | 6.6 | Hydroxy |
| | | | | | tyrosol |
| | | | | | related |
| | | | | | aglycon |
| 47.46 | 21635 | 0.9 | 33105 | 0.9 | Hydroxy |
| | | | | | tyrosol |
| | | | | | related |
| | | | | | aglycon |
| 49.26 | 114016 | 4.5 | 183249 | 7.5 | Tyrosol |
| | | | | | related |
| | | | | | aglycon |
| 49.74 | 34295 | | | | |
| 50.29 | 11411 | 0.5 | 87843 | 3.2 | Tyrosol |
| | | | | | related |
| | | | | | aglycon |
| 51.74 | 33161 | | 1616271 | | |
| 52.10 | | | 1616271 | | |
| 52.37 | 19644 | | 64896 | | |
| 52.90 | | | 64896 | | |
| 53.57 | | | 76154 | | |

*estimated concentrations

1. A method for increasing the polyphenol content in an oil, comprising the steps of mixing the oil with olive fruit material and maintaining the mixture for at least one minute and separating the oil from the mixture, where also an aqueous acid solution is incorporated in the mixture.

2. A method according to claim 1, wherein the aqueous acid solution has a pH of 2 or less.

3. A method according to claim 2, wherein the aqueous acid solution has a pH of 0 to 1.

4. A method according to claim 1, wherein the acid is selected from the group consisting of hydrochloric acid, citric acid, phosphoric acid, acetic acid, lactic acid and ascorbic acid.

5. A method according to claim 1, wherein the olive fruit material is selected from the group consisting of whole olive fruits, olive fruit particles and olive residue.

6. A method according to claim 1, wherein the oil is contacted with the olive fruit material at a temperature of at least 50° C.

7. A method according to claim 6, wherein the temperature is 90 to 100° C.

8. A method according to claim 1, wherein the oil is separated from the olive fruit material and the aqueous acid solution either by centrifugation or by filtration or by decanting.

9. A method according to claim 1, wherein the oil is an olive oil.

10. An oil, which when subjected to a HPLC analysis shows at least one peak situated between the group of peaks originating from aglycons which contain hydroxytyrosol or tyrosol moieties and the group of peaks originating from hydroxytyrosol and tyrosol themselves, of which at least one peak corresponds to a concentration of at least 1 ppm.

11. An oil according to claim 10, which when subjected to HPLC analysis under the following conditions
a Chrompack Intersil5 ODS column, a gradient flow rate of 1 ml/min and an elution system consisting of solvent A (2% acetic acid in water) and solvent B (methanol), gradient: 0-20 min., A/B 85/15%; 20-50 min., 15-75 B in A; 50-55 min., A/B 25/75, 55-56 min 75-100 B in A; 56-65 min. 100% B shows at least one peak in the area of a retention time of 15 to 30 minutes.

12. A food product containing an oil according to claim 10.

13. A food product according to claim 12, which is a mixture of a vegetable oil, preferably an olive oil and the oil according to claim 10.

14. A food product according to claim 12, which is selected from the group consisting of a spread, mayonnaise, salad dressing and tomato sauce.
